(19) United States
(12) Patent Application Publication
(10) Pub. No.: US 2025/0187615 A1
(43) Pub. Date: Jun. 12, 2025

(54) DRIVING DIAGNOSTIC SYSTEM

(71) Applicant: Toyota Jidosha Kabushiki Kaisha, Toyota-shi (JP)

(72) Inventors: Satoshi AKIMA, Nagakute-shi (JP); Yohsuke Hashimoto, Nagakute-shi (JP)

(73) Assignee: Toyota Jidosha Kabushiki Kaisha, Toyota-shi (JP)

(21) Appl. No.: 18/819,102

(22) Filed: Aug. 29, 2024

(30) Foreign Application Priority Data
Dec. 6, 2023 (JP) 2023-206393

(51) Int. Cl. B60W 50/02; B60W 30/16

(52) U.S. Cl. CPC B60W 50/0205; B60W 30/16; B60W 2050/021; B60W 2554/802

(57) ABSTRACT

A driving diagnostic system includes: a relative distance acquisition unit configured to acquire a relative distance according to an inter-vehicle distance between a host vehicle and a preceding vehicle and a speed of the host vehicle; a mode value acquisition unit configured to acquire a mode value of the relative distances; a mode class determination unit configured to group the relative distances into classes according to magnitudes of the relative distances and determine a mode class from the classes; and a diagnostic unit configured to diagnose driving content of the host vehicle based on the mode value or the mode class.

### CROSS-REFERENCE TO RELATED APPLICATION

This application claims priority to Japanese Patent Application No. 2023-206393 filed on Dec. 6, 2023, incorporated herein by reference in its entirety.

### BACKGROUND

### 1. Technical Field

The present disclosure relates to driving diagnostic systems.

### 2. Description of Related Art

There is a technique of diagnosing the driving content of a host vehicle based on the relative relationship between the host vehicle and a preceding vehicle. For example, there is a system that determines the driving content of a driver of a host vehicle to have a high degree of risk when the inter-vehicle time or inter-vehicle distance between the host vehicle and a preceding vehicle (hereinafter referred to as “both vehicles” as appropriate) is less than a predetermined value.

Japanese Unexamined Patent Application Publication No. 2015-151071 (JP 2015-151071 A) discloses a driving diagnostic device having a function to determine whether a driver of a host vehicle is performing high risk driving based on the inter-vehicle distance between the host vehicle and a preceding or following vehicle (hereinafter referred to as “another vehicle”). When the inter-vehicle distance between the host vehicle and another vehicle is less than a predetermined distance and the host vehicle performs driving that meets a certain condition, this driving diagnostic device determines that the driver of the host vehicle is performing risky driving and determines the driver's driving to have a high degree of risk. With such a configuration, the driving diagnostic device is described to be able to determine the right degree of risk according to the actual driving of the driver.

### SUMMARY

There is a system and method for diagnosing the driving content of a driver of a host vehicle based on the average value of the inter-vehicle distances between the host vehicle and a preceding vehicle, the number of times the inter-vehicle distance becomes smaller than a threshold, etc. If such a system and method correctly capture the driving characteristics such as how the driver keeps the inter-vehicle distance, it is possible to assist the driver in continuing safe driving or improving his/her driving by giving feedback on the results of the driving diagnosis to the driver. However, the distance between both vehicles sometimes decreases regardless of the driver's driving characteristics, that is, regardless of the driving operations of the driver of the host vehicle. For example, when a preceding vehicle suddenly decelerates or stops, or when a vehicle traveling in an adjacent lane cuts in front of the host vehicle and becomes a new preceding vehicle, the distance between both vehicles decreases due to the preceding vehicle. The distance between both vehicles also decreases when both vehicles are stuck in a traffic congestion. It is not desirable to determine a decrease in inter-vehicle distance to be due to the driver's driving characteristics and diagnose the driving content even when the driver cannot keep his/her desired inter-vehicle distance due to the surrounding traffic situation including behaviors of the preceding vehicle.

In the present specification, a driving diagnostic system is implemented that can diagnose the driving content in a manner that more reflects driver's driving characteristics by excluding from diagnosis the influence of the surrounding traffic situation including behaviors of a preceding vehicle etc.

A driving diagnostic system disclosed in the present specification includes: a relative distance acquisition unit configured to acquire a relative distance according to an inter-vehicle distance between a host vehicle and a preceding vehicle and a speed of the host vehicle;
a mode value acquisition unit configured to acquire a mode value of the relative distances;
a mode class determination unit configured to group the relative distances into classes according to magnitudes of the relative distances and determine a mode class from the classes; and
a diagnostic unit configured to diagnose driving content of the host vehicle based on the mode value or the mode class.

According to the above configuration, the driving content of a driver is diagnosed based on the mode value or mode class of the relative distances. As a result, it is possible to exclude from diagnosis the influence of the surrounding traffic situation that is included in diagnosis when diagnosis is performed based on the average value of the inter-vehicle distances between the host vehicle and the preceding vehicle or the number of times the inter-vehicle distance becomes smaller than a threshold, and it is possible to more reflect the driving characteristics of the driver in diagnosis.

In the driving diagnostic system,
the relative distance when the host vehicle and the preceding vehicle are in a stopped state may be the inter-vehicle distance.

With the above configuration, it is possible to diagnose the driving content based on the inter-vehicle distance the driver of the host vehicle keeps when he/she stops the host vehicle.

In the driving diagnostic system,
the relative distance when the host vehicle and the preceding vehicle are in a traveling state may be an inter-vehicle time between the host vehicle and the preceding vehicle.

In the above configuration, the inter-vehicle time is used as a condition for diagnosis. That is, the speed of the host vehicle is considered. Therefore, it is possible to exclude from diagnosis of the driving content the influence of a situation that is not suitable for determination, such as a situation in which the driver is stuck in a traffic congestion.

The driving diagnostic system disclosed in the present specification diagnoses the driving content based on the mode value or mode class of the relative distances. As a result, it is possible to exclude from diagnosis the influence of the surrounding traffic situation that is included in diagnosis when diagnosis is performed based on the average value of the inter-vehicle distances between the host vehicle and the preceding vehicle or the number of times the inter-vehicle distance becomes smaller than a threshold, and it is possible to more reflect the characteristics of the driver in diagnosis.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a driving diagnostic system;

FIG. 2 is a flow chart illustrating a flow of a process of the driving diagnostic system according to the embodiment; and

FIG. 3 is a diagram illustrating an example of a screen when the contents of the driving diagnosis are fed back to the driver.

### DETAILED DESCRIPTION OF EMBODIMENTS

Hereinafter, a driving diagnostic system will be described with reference to the drawings.

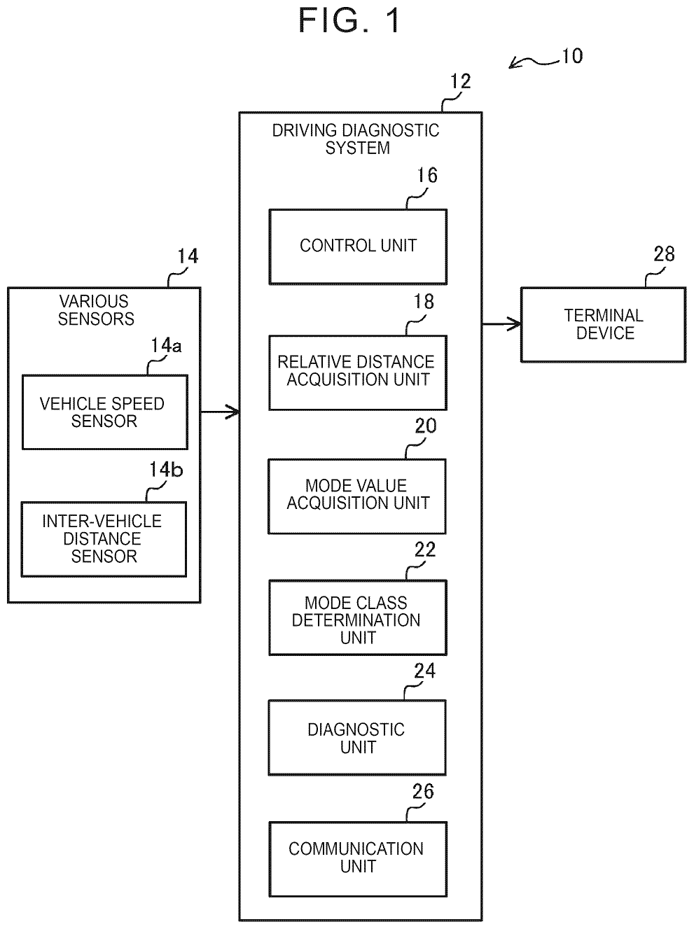

FIG. 1 is a block diagram illustrating a configuration of a driving diagnostic system. As illustrated in FIG. 1, in the embodiment, a driving diagnostic system 12 and various sensors 14 are mounted on a vehicle 10 (hereinafter, referred to as a “host vehicle 10”) that is a diagnosis target of driving contents. The driving diagnostic system 12 is a system that receives various kinds of information on the host vehicle 10 and the preceding vehicle acquired by the various sensors 14, and diagnoses the driving contents of the host vehicle 10 based on the received information. Although details will be described later, the driving diagnostic system 12 can also be utilized to support the continuation of the safe driving of the driver or the improvement of the driving by feeding back the diagnosis result of the driving content to the driver of the host vehicle 10 or the like. Note that the “preceding vehicle” is another vehicle traveling immediately before the host vehicle 10 in the lane in which the host vehicle 10 is currently traveling.

The various sensors 14 are devices that detect a specific numerical value related to the host vehicle 10 and a change amount thereof in order to acquire the traveling state of the host vehicle 10. FIG. 1 illustrates a vehicle speed sensor 14a for detecting a speed of the host vehicle 10 (hereinafter, also referred to as “host vehicle speed”) and an inter-vehicle distance sensor 14b for determining an inter-vehicle distance between the host vehicle 10 and the preceding vehicle, as an exemplary example of the various sensors 14. The various sensors 14 are not limited to the above-described sensor 14a, 14b, and may include, for example, a camera that captures an image of a situation around the host vehicle 10, a sensor that detects a degree of depression of an accelerator of the host vehicle 10, a steering angle of a steering wheel, and the like. The various sensors 14 are not limited to the sensors mounted on the host vehicle 10.

As illustrated in FIG. 1, the driving diagnostic system 12 includes a control unit 16, a relative distance acquisition unit 18, a mode value acquisition unit 20, a mode class determination unit 22, a diagnostic unit 24, and a communication unit 26.

The control unit 16 is an electronic control unit having at least a CPU for performing various arithmetic operations and a memory in which control programs and data are stored. The respective functions of the relative distance acquisition unit 18, the mode value acquisition unit 20, the mode class determination unit 22, the diagnostic unit 24, and the communication unit 26 are realized by the control unit 16.

The relative distance acquisition unit 18 acquires the inter-vehicle distance between the host vehicle 10 and the preceding vehicle and the relative distance corresponding to the speed of the host vehicle 10. In the present example, the inter-vehicle distance is an absolute distance between the host vehicle 10 and the preceding vehicle. On the other hand, the relative distance is a relative distance obtained according to the inter-vehicle distance and the speed of the host vehicle 10, and is specifically obtained by dividing the inter-vehicle distance by the speed of the host vehicle 10. That is, the relative distance is a distance in consideration of the speed of the host vehicle 10. Therefore, when the host vehicle 10 is in the stopped state, since the host vehicle speed is 0, the relative distance does not influence the relative distance, and the relationship of relative distance=inter-vehicle distance holds.

The mode value acquisition unit 20 acquires the mode value from among the relative distances. For example, the mode value acquisition unit 20 acquires the relative distance between the host vehicle 10 and the preceding vehicle at predetermined time intervals, and obtains the mode value from the acquired relative distance.

Whereas the mode value acquisition unit 20 obtains a limited value of the mode value, the mode class determination unit 22 performs determination by allocating the relative distance to a range having a certain width. That is, the mode class determination unit 22 first groups the relative distances into classes according to the magnitudes of the relative distances, and determines the mode class from the classes. For example, the mode class determination unit 22 acquires the relative distance between the host vehicle 10 and the preceding vehicle at predetermined time intervals. Then, the mode class determination unit 22 allocates each of the plurality of acquired relative distances to a corresponding one of predetermined classes (for example, classes such as 0 m or more and less than 1 m, or 1 m or more and less than 2 m, . . . , 10 m or more). Then, the mode class determination unit 22 determines the class into which the largest number of relative distances is allocated out of the predetermined classes (i.e., mode class).

The diagnostic unit 24 diagnoses the driving content of the host vehicle 10 based on the mode value obtained by the mode value acquisition unit 20 or the mode class determined by the mode class determination unit 22. For example, the diagnostic unit 24 compares the mode value of the relative distances or the mode class of the relative distances with a relative distance (hereinafter, referred to as “safe relative distance”) suitable for a predetermined safe driving. Then, the diagnostic unit 24 determines whether or not the relative distance of the host vehicle 10 is included in the range of the safe relative distance (that is, whether or not the relative distance taken by the driver of the host vehicle 10 in normal driving is the safe relative distance).

The communication unit 26 is a communication interface and transmits and receives data between the driving diagnostic system 12 and an external device via a communication network (not shown). For example, in a case where the various sensors 14 are outside the host vehicle 10 or in a case where the information detected by the various sensors 14 is stored in a device outside the host vehicle 10, the information is provided to the driving diagnostic system 12 via the communication unit 26. Further, the diagnosis content in the diagnostic unit 24 is transmitted to the terminal device 28 described later, and the diagnosis content is also transmitted via the communication unit 26.

The terminal device 28 illustrated in FIG. 1 is a device carried by a driver of the host vehicle 10, and is, for example, a commonly used smartphone or the like. An application for providing the contents of the driving diagnosis of the host vehicle 10 is installed in the terminal device 28. In the embodiment, the contents of the driving diagnosis of the host vehicle 10 are fed back to the driver by using the application.

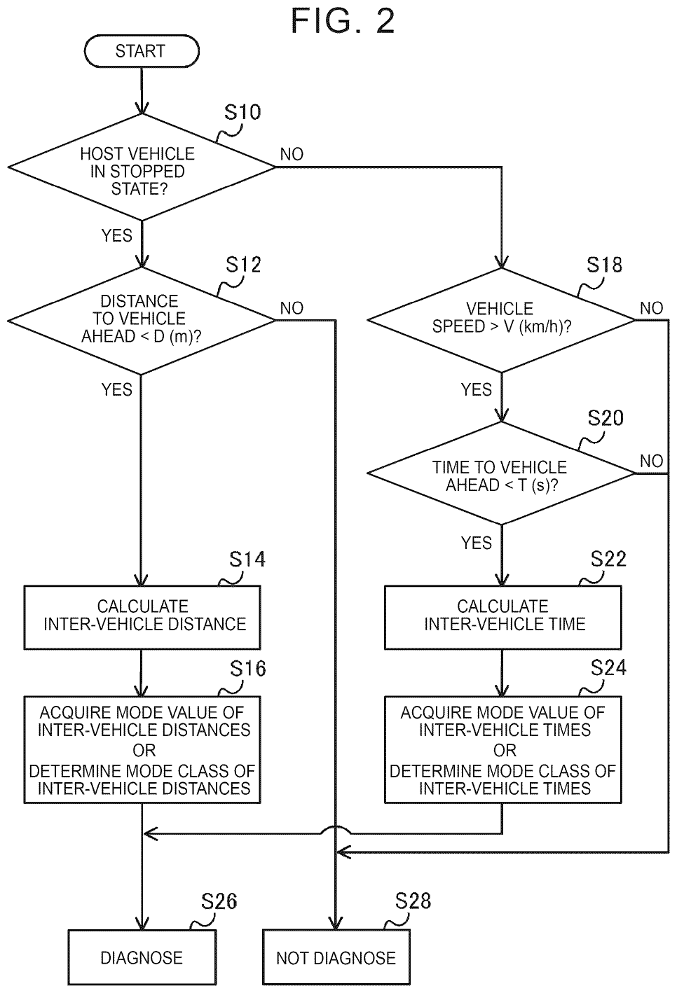

Next, the processing according to the embodiment will be further described with reference to FIG. 2. FIG. 2 is a flowchart illustrating a flow of processing of the driving diagnostic system according to the embodiment. In the embodiment, as described above, the control unit 16 controls the operation of each unit of the driving diagnostic system 12 and performs a series of processes related to the driving diagnosis.

First, the control unit 16 determines whether the host vehicle 10 is in a stopped state (S10). When the host vehicle 10 is in a stopped state (Yes in S10), the control unit 16 determines whether or not the distance between the host vehicle 10 and a vehicle (hereinafter, referred to as a “front vehicle”) that is stopping ahead of the host vehicle 10 is less than D [m] (S12). In this example, the front vehicle is also in a stopped state. Here, D [m] is a predetermined condition value, and is a value used for determining whether or not the front vehicle satisfies the condition as the preceding vehicle. For example, when the host vehicle 10 is stopped, the driver generally causes the driver to stop in consideration of the inter-vehicle distance between the vehicle and the front vehicle. However, there is a case where the distance between the host vehicle 10 and the front vehicle is large at a position where the front vehicle does not affect the stopping operation of the driver. In such a case, from the viewpoint of the relative distance, it is appropriate to determine that the front vehicle is not a preceding vehicle, and that the preceding vehicle is not present in the host vehicle 10. Therefore, when the distance between the host vehicle 10 and the front vehicle is not less than D [m] (No in S12), the control unit 16 does not diagnose the driving content based on the relative distance (S28), and ends the series of processes. On the other hand, when the distance between the host vehicle 10 and the front vehicle is less than D [m] (Yes in S12), the process proceeds to S14.

Next, when the distance between the host vehicle 10 and the front vehicle (hereinafter referred to as “both vehicles” since this distance can be said to be the relationship between the host vehicle 10 and the preceding vehicle in S14 and the subsequent steps) is less than D [m], the control unit 16 determines the inter-vehicle distance between both vehicles (S14). Then, the control unit 16 obtains a mode value or mode class of the inter-vehicle distances between both vehicles (S16). For example, in a case where the host vehicle 10 stops 10 times in a state where the preceding vehicle is present during one trip, the control unit 16 acquires the inter-vehicle distances of the 10 times and obtains the most frequent inter-vehicle distances among the obtained inter-vehicle distances. When obtaining the mode class, the control unit 16 first groups the inter-vehicle distances into classes such as “0 m or more and less than 1 m” and “1 m or more and less than 2 m,” and obtains the class to which the 10 inter-vehicle distances belong most frequency. Note that “one trip” refers to traveling until the engine or the vehicle system is stopped by pressing the engine switch or the power switch again after the vehicle is started by pressing the engine switch or the power switch, for example.

The control unit 16 diagnoses the driving content of the host vehicle 10 based on the mode value or mode class of the inter-vehicle distance between both vehicles obtained above (S26). As described above, in the present example, the mode value or mode class of the inter-vehicle distances between both vehicles is used as the diagnosis data. As a result, for example, in a case where the host vehicle 10 stops suddenly and a sufficient inter-vehicle distance cannot be obtained due to the sudden stop of the preceding vehicle, an exceptional event can be removed from the data for diagnosis. As a result, the driving characteristics of the driver can be reflected in the diagnosis.

Next, returning to S10, a process when it is determined that the host vehicle 10 is not in a stopped state (No in S10) will be described. First, the control unit 16 determines whether or not the vehicle speed of the host vehicle 10 is greater than V [km/h] (S18). In this example, the front vehicle is also set to the traveling state. Here, V [km/h] is a predetermined conditional value, and is a value used for a determination to exclude a case where the desired inter-vehicle distance of the driver cannot be secured due to the surrounding traffic conditions including the behavior of the preceding vehicle. For example, the traveling speed of the host vehicle 10 is low when the host vehicle 10 is caught in a traffic jam, immediately after the start of the host vehicle 10, immediately before the stop, or the like. Therefore, when V [km/h] is set to a value that is recognized as the low-speed running as described above, and the host vehicle 10 is equal to or less than V [km/h] (No in S18), the control unit 16 does not diagnose the driving content based on the relative distance (S28), and ends the series of processes. On the other hand, when the vehicle speed of the host vehicle 10 is larger than V [km/h] (Yes in S18), the process proceeds to S20.

Next, when the vehicle speed of the host vehicle 10 is greater than V [km/h], the control unit 16 determines whether or not the time-difference between the host vehicle 10 and the vehicle traveling ahead of the host vehicle 10 (hereinafter, referred to as “front vehicle”) is less than t [s] (S20). Here, the “time difference” specifically refers to the relative time. The relative time is a value calculated by dividing the distance between the host vehicle 10 and the front vehicle by the difference in speed (that is, the relative speed), and indicates the time until the host vehicle 10 reaches the current position of the front vehicle. The t [s] is a predetermined condition value and is a value used for determining whether or not the front vehicle satisfies the condition as the preceding vehicle. The relative time between the host vehicle 10 and the front vehicle may be too large. In this case, as in D [m] described in the above S12, from the viewpoint of the relative distance, it is appropriate to determine that the front vehicle is not a preceding vehicle and that the preceding vehicle is not present in the host vehicle 10. Therefore, when the time difference between the host vehicle 10 and the front vehicle is not less than t [s] (No in S20), the control unit 16 does not diagnose the driving content based on the relative distance (S28), and ends the series of processes. On the other hand, when the time-difference between the host vehicle 10 and the front vehicle is less than t [s] (Yes in S20), the process proceeds to S22.

Next, when the time difference between the host vehicle 10 and the front vehicle (hereafter referred to as “both vehicles” since this time difference can be said to be the relationship between the host vehicle 10 and the preceding vehicle in S22 and the subsequent steps) is less than t [s], the control unit 16 determines the inter-vehicle time between both vehicles (S22). In the present example, the inter-vehicle time is synonymous with the above-described relative distance, and is calculated based on the inter-vehicle distance and the speed of the host vehicle 10, and is specifically obtained by dividing the inter-vehicle distance by the speed of the host vehicle 10. For example, when the inter-vehicle distance between the host vehicle 10 and the preceding vehicle is 22.2 m and the vehicle speed of the host vehicle 10 is 40 km/h, the inter-vehicle time is 1.98 seconds, which is approximate to 2 seconds, which is a measure of the inter-vehicle time on the ordinary road.

Subsequently, the control unit 16 obtains a mode value or mode class of the inter-vehicle times between both vehicles (S24), and diagnoses the driving content of the host vehicle 10 based on the obtained mode value or mode class of the inter-vehicle times (S26). As in the case of the inter-vehicle distance described above, since the mode value or mode class of the inter-vehicle times between both vehicles is used as the diagnosis data, by executing the process in S24 from S18, the driving characteristics of the drivers can be reflected in the diagnosis.

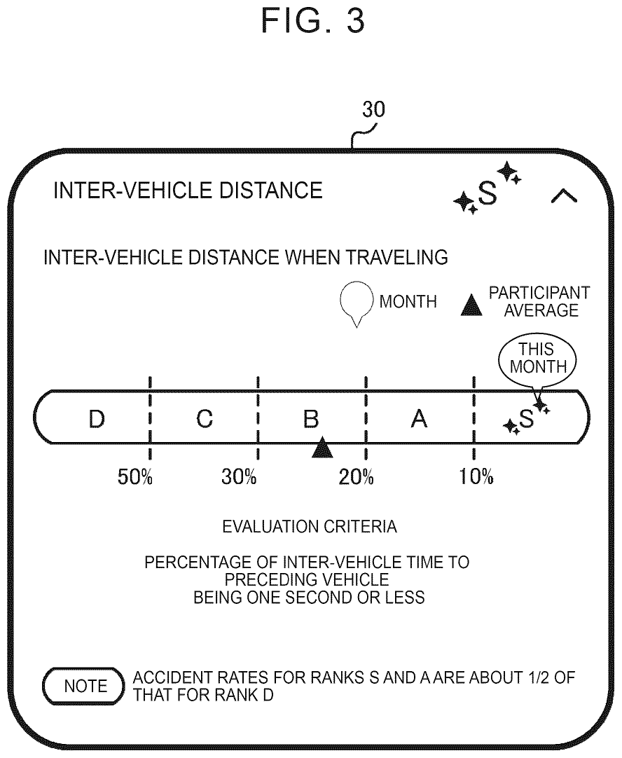

The contents of the driving diagnosis described above can be provided as effective information for the driver to continue the safe driving in the future or to improve the driving. A specific example of providing the information will be described with reference to FIG. 3. FIG. 3 is a diagram illustrating an example of a screen when the contents of the driving diagnosis are fed back to the driver. Specifically, the screen 30 illustrated in FIG. 3 is an example of a screen of an application installed in the terminal device 28 carried by the driver of the host vehicle 10. On the screen 30, evaluation of how to set the inter-vehicle distance during traveling of the host vehicle 10 and other information are presented. Specifically, the content of the screen 30 tells the driver to which rank the way the driver keeps the inter-vehicle distance during driving in a certain month belongs to. Further, as an example, evaluation criteria, reference information, and an average of the inter-vehicle distances of the other participants are shown, so that the driver can grasp what kind of inter-vehicle distance arrangement leads to safe driving. In this example, “inter-vehicle distance S” is displayed at the top of the screen 30. Therefore, by obtaining this feedback, the driver can know that the accident rate is low in the way of taking the inter-vehicle distance during the driving of the driver, and it is expected that the driver will continue the safe driving more consciously. In addition, if the rank is not S but is a low rank such as C or D, providing the feedback to the driver leads to support for the driver to be conscious of safe driving and to actively improve driving.

Note that the description so far is an example. The driving diagnostic system of the present disclosure may be configured such that a mode value or mode class is obtained from the relative distances according to the inter-vehicle distances between the host vehicle and the preceding vehicle and the host vehicle speed, and the driving content in the host vehicle is diagnosed based on the mode value or the mode class Accordingly, other configurations of the driving diagnostic system may be changed as appropriate. For example, as shown in FIG. 1, in the embodiment, since the diagnostic unit 24 is a part of the driving diagnostic system 12 mounted on the host vehicle 10, it is mounted on the host vehicle 10, but the present disclosure is not limited thereto. For example, the diagnostic unit 24 may be located in a data center outside the host vehicle 10 or in a data server on the cloud. In such a configuration, the control unit 16 of the driving diagnostic system 12 transmits and receives information used for driving diagnosis and diagnosis results to and from the data center or the like via the communication unit 26.

What is claimed is:

1. A driving diagnostic system comprising:
a relative distance acquisition unit configured to acquire a relative distance according to an inter-vehicle distance between a host vehicle and a preceding vehicle and a speed of the host vehicle;
a mode value acquisition unit configured to acquire a mode value of the relative distances;
a mode class determination unit configured to group the relative distances into classes according to magnitudes of the relative distances and determine a mode class from the classes; and
a diagnostic unit configured to diagnose driving content of the host vehicle based on the mode value or the mode class.

2. The driving diagnostic system according to claim 1, wherein the relative distance when the host vehicle and the preceding vehicle are in a stopped state is the inter-vehicle distance.

3. The driving diagnostic system according to claim 1, wherein the relative distance when the host vehicle and the preceding vehicle are in a traveling state is an inter-vehicle time between the host vehicle and the preceding vehicle.
